(19) United States
(12) Patent Application Publication
(10) Pub. No.: US 2017/0249762 A1
(43) Pub. Date: Aug. 31, 2017

(54) Critical Path Detection in Job

(71) Applicant: Microsoft Technology Licensing, LLC, Redmond, WA (US)

(72) Inventors: Yifung Lin, Beijing (CN); Omid Afnan, Beijing (CN); Dian Zhang, Beijing (CN)

(21) Appl. No.: 15/056,852

(22) Filed: Feb. 29, 2016

(51) Int. Cl. G06T 11/20; G06F 9/50

(52) U.S. Cl. CPC G06T 11/206; G06F 9/5083

(57) ABSTRACT

Identifying a path for a distributed job. A method includes dynamically collecting timing and relationship information for vertices in stages of a running job. The method further includes identifying a particular vertex. The method further includes iteratively identifying a single path parent-child sequence path for the identified vertex. The method further includes displaying a Gantt chart showing the identified path, wherein the Gantt chart shows timing relationships and execution progress information.

### BACKGROUND

### Background and Relevant Art

Computers and computing systems have affected nearly every aspect of modern living. Computers are generally involved in work, recreation, healthcare, transportation, entertainment, household management, etc.

Further, computing system functionality can be enhanced by a computing systems' ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing systems.

Interconnection of computing systems has facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc).

Cloud jobs typically involve a number of different stages coupled together. Each stage includes one or more vertices. Each vertex in a stage performs a given set of operations. Typically all vertices in a stage perform the same set of operations, but on different data. From stage to stage, there are parent-child relationships between vertices. Thus, for example, a vertex in one stage will be a parent or child to a different vertex in a different stage. The parent child relationships define operation and/or data flow.

Often, in cloud environments, different vertices from the same stage will be implemented on different machines in a given cloud environment. For example, a given machine may be able to handle four vertices, while a given stage may have hundreds of vertices.

Improving the performance of cloud jobs is a difficult task. Traditional approaches include trial and error, scouring code to attempt to identify issues with a user's script, and/or scouring through run results for clues of ways to improve performance or identify problems.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method that may be practiced in a distributed computing environment. The method includes acts for identifying a path for a distributed job. The method includes dynamically collecting timing and relationship information for vertices in stages of a running job. The method further includes identifying a particular vertex. The method further includes iteratively identifying a single path parent-child sequence path for the identified vertex. The method further includes displaying a Gantt chart showing the identified path, wherein the Gantt chart shows timing relationships and execution progress information.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a system 100 that can be used to identify single parent-child sequence operation paths to a user;

FIG. 2 illustrates a graphical user interface showing a graph view of a job graph;

FIG. 3 illustrates a vertex execution view in the graphical user interface;

FIG. 4 illustrates a critical path being displayed in a Gantt chart in the graphical user interface;

FIG. 5 illustrates selection of a vertex in the graphical user interface and displaying statistics for the selected vertex in the graphical user interface;

FIG. 6 illustrates a detailed view of a vertex being displayed in the graphical user interface;

FIG. 7 illustrates a zoomed in view in the user interface showing operations;

FIG. 8 illustrates the user interface showing code for an operation; and

FIG. 9 illustrates a method of identifying a path for a distributed job.

### DETAILED DESCRIPTION

Embodiments illustrated herein can identify single parent-child sequence operation paths, which can then be used to identify areas for improvement. In some embodiments, the single parent-child sequence path may be a critical path as defined below. With the critical path identified, developers are able to focus quickly on the areas that are needed for improvement. However, other embodiments can identify other single parent-child sequence operation paths. In some embodiments, the critical path can be graphically presented to the user, in a user interface, in a Gantt chart so that the user can quickly and efficiently identify vertices that most contribute to the amount of time a jobs takes to complete.

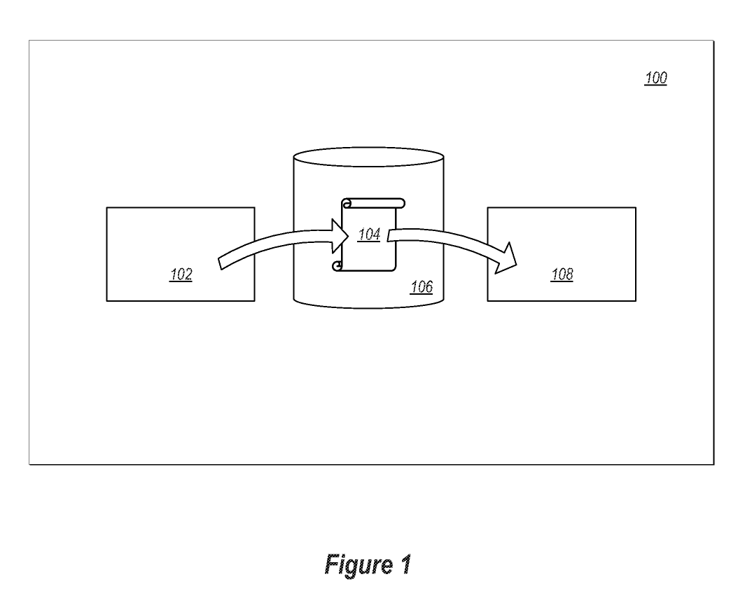

FIG. 1 illustrates a system 100 that can be used to identify single parent-child sequence operation paths to a user. The details of the system 100 will be discussed in conjunction with the other Figures.

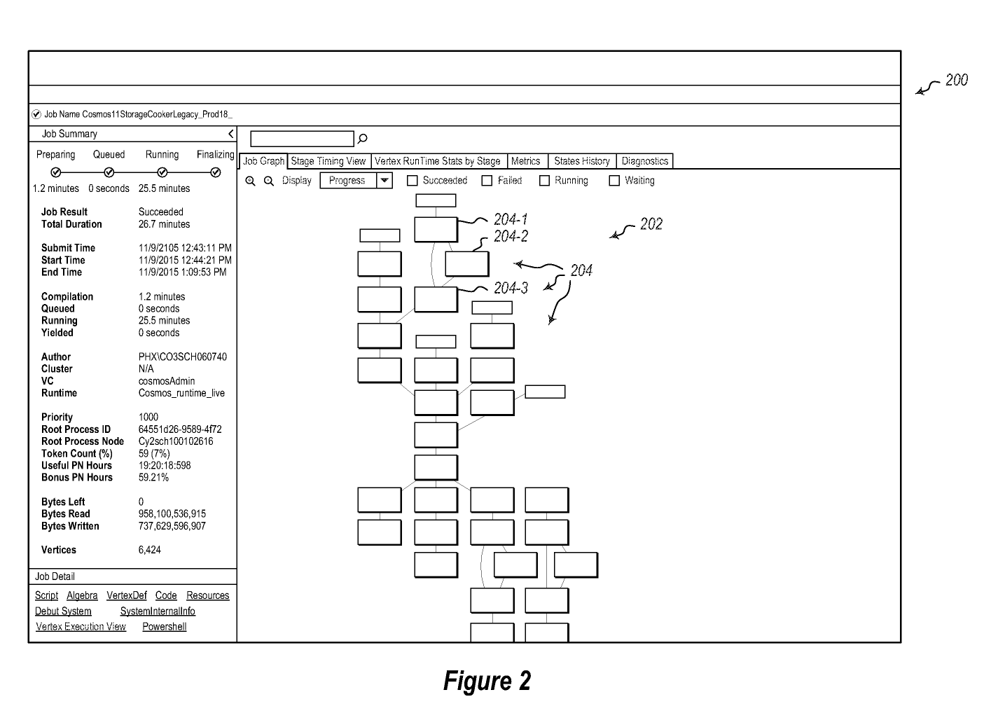

As noted above, and with reference now to FIG. 2 (which illustrates a graph view 200 of a graphical user interface showing a job graph 202), cloud jobs typically involve a number of different stages coupled together. A stage is a set of computations that can be performed in a linear and acyclic sequence to be applied once to a given data element. For example, FIG. 2 illustrates the graph 202 with a plurality of stages 204 coupled to each other by various parent-child relationships. Each stage includes one or more vertices, but often, a given stage will include multiple, perhaps even hundreds or thousands of (or even more) vertices. A vertex is a set of related computations (such as those defined by a stage) together with a particular instance of input data to be acted on. Each vertex in a stage performs a given set of operations. Typically all vertices in a stage perform the same set of operations, but on different data. From stage to stage, there are parent-child relationships between vertices. Thus, for example, a vertex in one stage will be a parent or child to a different vertex in a different stage. For example, a vertex from stage 204-1 may be a parent vertex to a vertex from stage 204-2. The parent child relationships define operation and/or data flow.

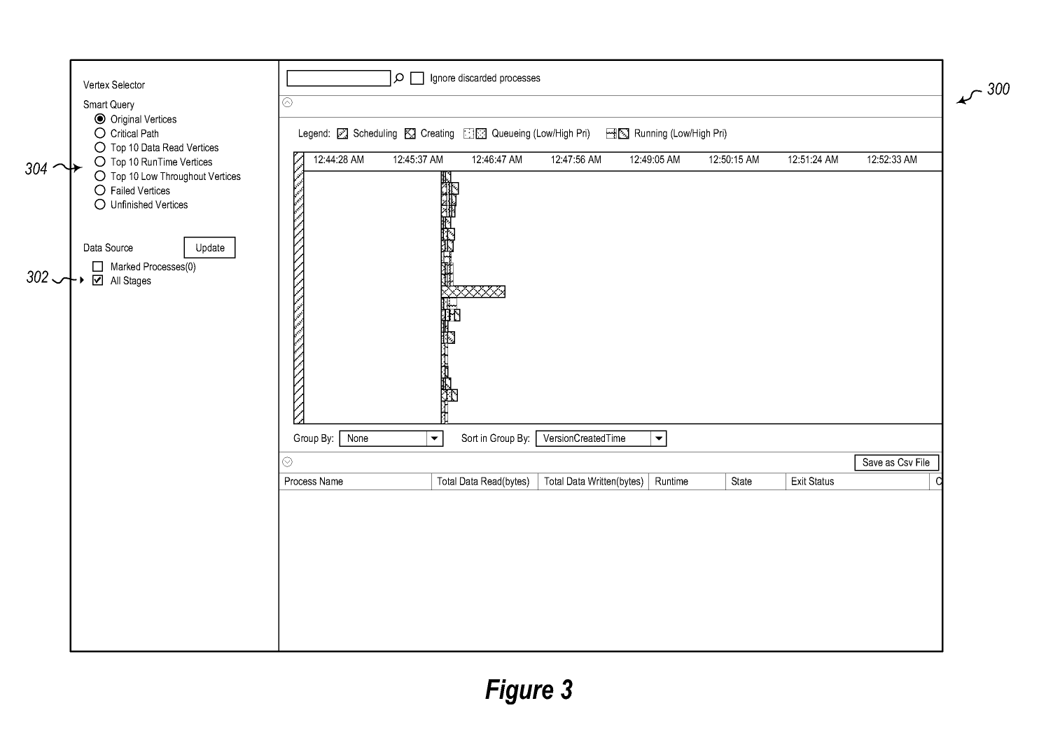

Referring now to FIG. 3, a vertex execution view 300 is illustrated in the graphical user interface. The vertex execution view 300 may be provided to a user in the user interface. The vertex execution view 300 graphically displays all of the vertices in a Gantt like display so the user can see the timeline of vertices for the job. Note that the vertex execution view 300 includes various user selectable elements. For example, FIG. 3 illustrates a stage selection element 302. Here a user can select which stages for which the user wishes to see vertices. In the illustrated example, the stage selection element 302 can be expanded to a tree view that allows the user to select individual stages from the job graph 202. In the example illustrated, the user has selected to view all stages.

The vertex execution view further includes various other selectable elements 304 that allow for filtering of vertices. For example, a user can select to view all vertices by selecting the ‘original vertices’ option; to view only vertices in the critical path by selecting the ‘Critical Path’ option; to view only the top 10 data read vertices by selecting the ‘Top 10 Read Vertices’ option; to view only the top 10 longest running vertices by selecting the ‘Top 10 Run Time Vertices’ option; to view only the top 10 low throughput vertices by selecting the ‘Top 10 Low Throughput Vertices’ option; to view only failed vertices by selecting the ‘Failed Vertices’ option; to view only unfinished vertices by selecting the ‘Unfinished Vertices option’, etc. Note that these filter options are only examples and other or different filter options could be implemented.

Also note that vertex execution information is collected dynamically as a job is running, and therefore additional vertices may be added to the vertex execution view 300, and representations of existing vertices in the vertex execution view 300 may change over time as the vertices proceed with execution. For example, as illustrated, the vertices may be illustrated with color coding to illustrate execution progress. Thus, over time, the representations will change as vertices are scheduled, created, queued, and run. Thus, the execution view 300 may change over time to show such progression.

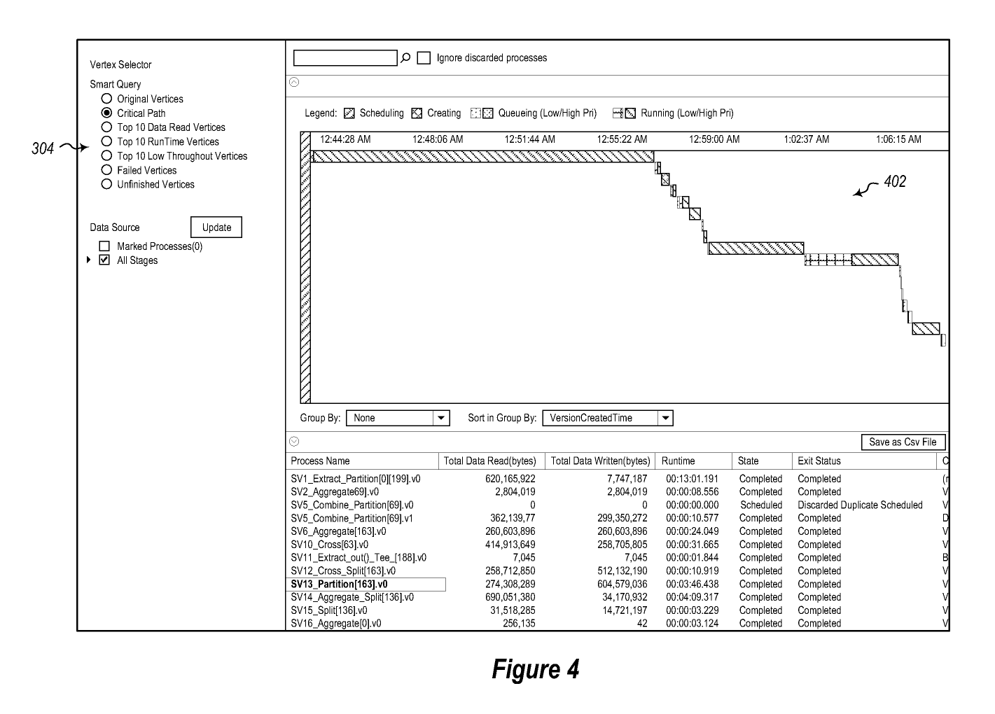

As illustrated in FIG. 4, embodiments allow users to select the ‘Critical Path’ option from the selectable elements 304 to allow the user to view cloud job execution in a Gantt view with the critical path of the job programmatically identified as illustrated at the critical path representation 402. With this, developers can directly analyze performance issues with their jobs. They can quickly find the bottlenecks and areas to focus on to improve performance.

The critical path is defined as the longest running, single path, parent-child vertex sequence of a job. A single path is one in which each parent has only a single child and each child has only a single parent. Thus, for example, with reference to FIG. 2, while a vertex in stage 204-3 will have two parent vertices, one in stage 204-1 and one in stage 204-2, only one of these parent vertices will be selected to be included in the single path parent-child vertex, namely, the parent that contributes to the longest running sequence. This may be due to a given parent having a long run time, or an ancestor of the given parent having a long run time.

Returning now to FIG. 4, embodiments present the critical path representation 402 to the user in a timeline view of all the vertices along the critical path. By analyzing and focusing on the vertices in the critical path, users are able to solve bottlenecks and improve the performance of their jobs, as will be illustrated further below.

Referring once again to FIG. 1, the critical path is computed based on the job's vertex execution information. While the job runs, a job manager 102 schedules vertices 102 based on the compiled algebra. Note that the compiled algebra is represented by the job graph 202. Indeed, the job graph 202 may be created in the user interface using the compiled algebra.

The scheduled vertices form a directed acyclic graph, and the job manager 102 writes their timing information into a job profile 104 stored in a datastore 106. The timing information in the job profile 104 in the illustrated example contains each vertex's creation time, queued time, executing time, and completed time. In the embodiments illustrated, this is stored as a series of timing entries, one for each time a particular vertex changes state.

In addition, the job profile 104 also contains information identifying each vertex's parent vertex. The job profile 104 may be written in a big data file system so it can be downloaded and parsed by client tools. Note that in some embodiments, to save on system memory when processing the job profile 104, the job profile may be streamed rather than loaded in its entirety into memory. In particular, the job profile 104 may be stored in a file that can be streamed.

To calculate the critical path when the job has completed, a path computation engine 108, which may include a specially programmed processor and/or memory resources, uses the job profile 104 and accesses an entry in the job profile 104 for the last completed vertex. Using this entry, the path computation engine 108 iteratively walks, beginning at the last completed vertex (or other vertex if a path other than the critical path is being identified) from child to parent of vertices. Thus, for example, the computation engine identifies a parent of the last completed vertex. Then the path computation engine 108 identities a parent of the parent of the last completed vertex, and so forth up to a vertex at the start of the job. That sequence identifies the job's longest running vertex sequence. Once the job completes there is typically only one critical path sequence.

Note that in some situations, a parent may not be able to be identified for a particular vertex for various reasons. For example, a machine that hosted the parent vertex may fail. In such cases, the parent vertex can be recreated and re-run on a different host machine so as to be able to add the parent to the path. In one example, the job manager 102 will track execution of all vertices. If a vertex fails with an error, or runs too long, it can start another vertex with the same code and data. The child vertex would then also be recreated or restart its processing of data coming from the parent.

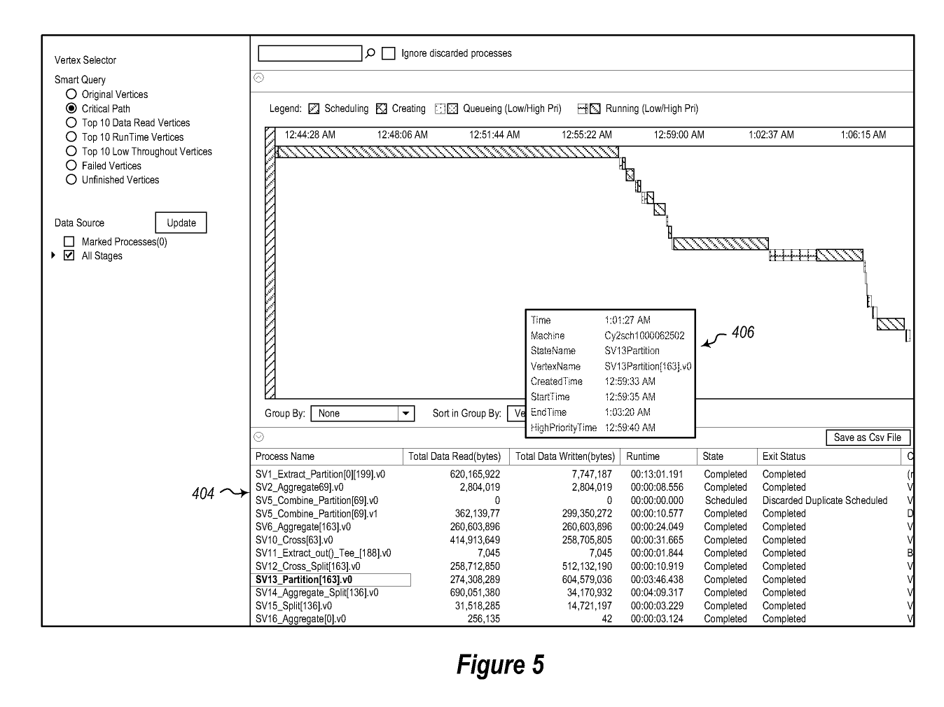

Bottle necks can be resolved by examining vertices in the critical path in other paths). Embodiments include functionality for facilitating a user examining vertices. For example, reference is now made to FIG. 5. FIG. 5 illustrates that a user can select a particular vertex for further review in the user interface. In the illustrated example, a user can select, such as by mouse clicking on either the vertex in the Gantt view of the critical path representation 402 or by selecting the vertex from a list view. In the illustrated example, selecting a vertex will cause a statistics window 406 to be displayed with various statistics about the vertex. For example, the statistics window 406 can include information about the vertex including what machine the vertex ran on, the stage that the vertex was included in, the vertex name, when the vertex was created, when the vertex started ing, when the vertex ended running, when the vertex started running as a high priority vertex, etc. Note that the list view 404 also includes various statistics about the job. For example, in the illustrated example, the list view includes total data written by the job, total data read by the job, amount of time the job ran, the state of the job, and how the job exited. Embodiments can vary how the statistics are presented to a user, and the examples illustrated are just examples. Other embodiments may have other representations.

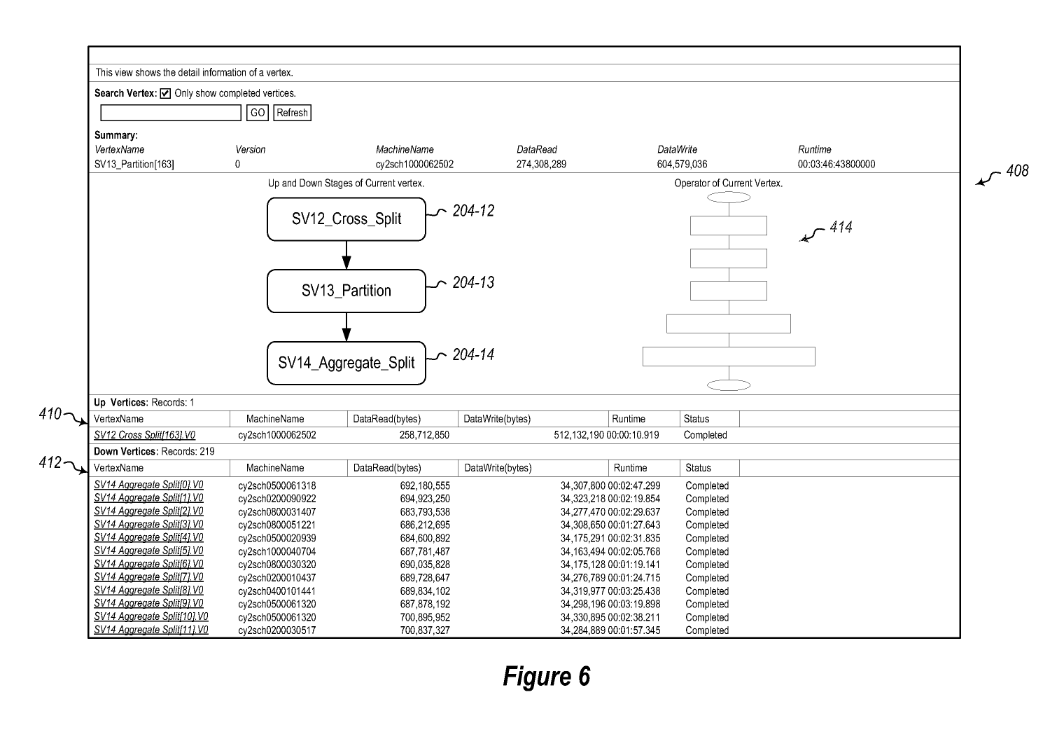

A user can obtain additional details about a vertex. For example, by double clicking the vertex in the user interface (or other appropriate interaction with a vertex) a detailed view of the vertex can be obtained. FIG. 6 illustrates such a detailed view 408. In particular, FIG. 6 illustrates the stage 204-13 containing the vertex along with a stage 204-12 having a parent vertex for the vertex and a stage 204-14 having one or more child vertices for the vertex. Additionally, the detailed view 408 includes list 410 of a parent vertex for the vertex, and a list 412 of child vertices for the vertex.

Additionally, the detailed view 408 includes an illustration 410 of operations for the current vertex. This includes a list of computing operations that are performed by running the vertex.

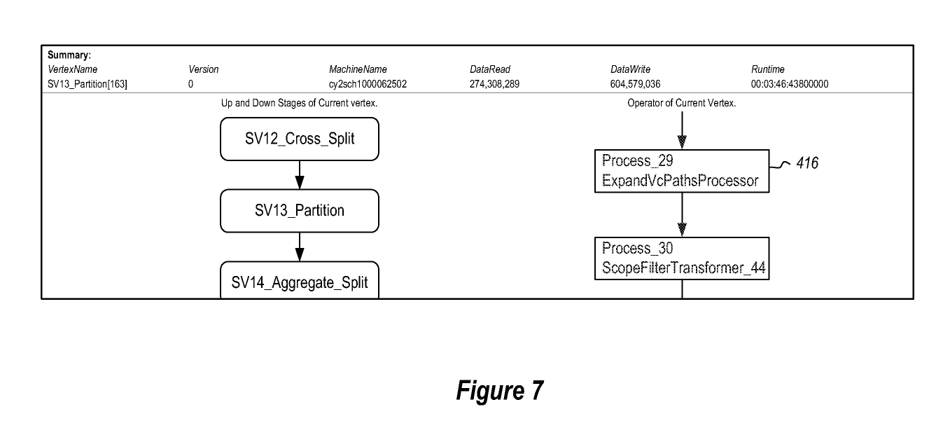

A user could obtain still further information by selecting one or more of the operations in the illustration 416 in the user interface. For example, FIG. 7 illustrates a zoomed in view in the user interface of some of the operations for the vertex. A user could select the operation 416 in the user interface.

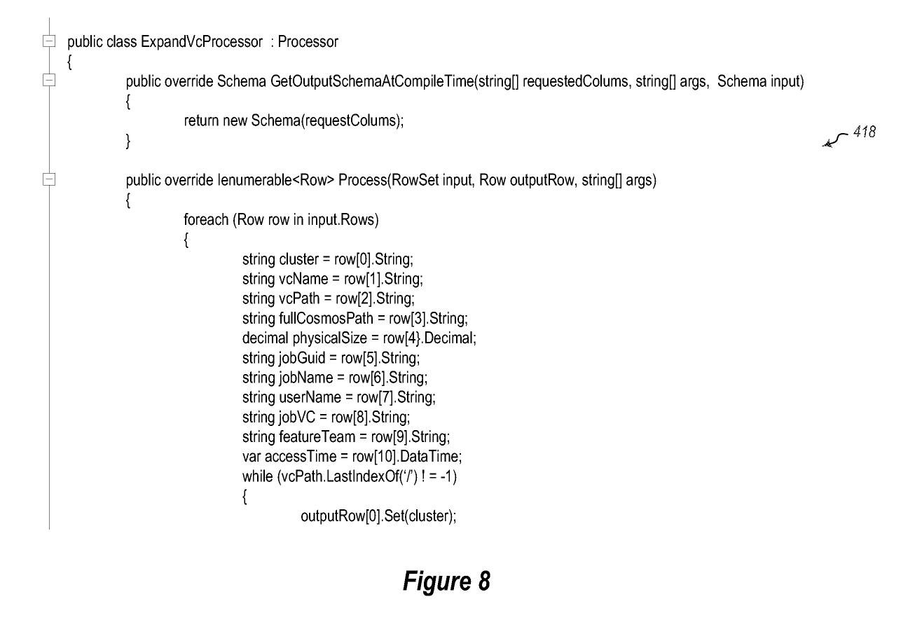

In the illustrated example, this would cause code 418 for the operation to be displayed in the user interface, as illustrated in FIG. 8. In this way, a user can drill down to code for particular operations of a vertex in an efficient manner. Indeed systems can help users quickly identify the critical path (i.e., the longest running path), identify vertices in the path that may be less efficient than desired, and examine operations in the vertices in an efficient manner.

Thus, embodiments can create efficient user interface organization and interaction for a user to allow the user to quickly identify potential bottle necks, or other issues, in a vertex path for distributed computing systems. This allows the user to more quickly identify issues for computing systems to be more efficient as less computing time and interaction time is needed to identify and correct various issues.

As bottle necks are resolved, the critical path will change, and new bottle necks can be identified in the new critical path. Thus, embodiments can iteratively perform the actions illustrated herein to iteratively identify bottlenecks. In particular, the most time consuming sequence is identified, which can then be optimized so that the next most time consuming sequence becomes the most time consuming sequence, which can then be optimized. This can iteratively be performed so as to iteratively improve cloud execution by addressing the critical path.

As noted previously, embodiments may be configured to record all the timings of the actual endpoints while the job is running, and process them during or after the job run. Thus, embodiments are configured to handle live jobs. Embodiments can mine and/or process data for the user.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

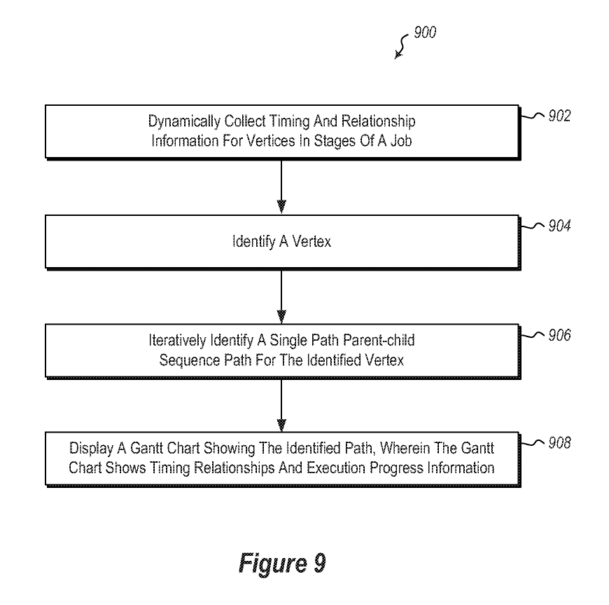

Referring now to FIG. 9, a method 900 is illustrated. The method may be practiced in a distributed computing environment, such as a cloud environment. The method may include acts for identifying a path for a distributed job. This can be used, for example, to facilitate performance optimizations by identifying bottlenecks. The method 900 includes dynamically collecting timing and relationship information for vertices in stages of a running job (act 902). For example, the job manager 102 may collect relationship and timing information in a job profile 104.

The method 900 further includes identifying a vertex (act 904). For example, the path computation engine 108 may access the job profile 104 to find a last completed vertex (or other vertex based on some other criteria).

The method 900 further includes iteratively identify a single path parent-child sequence path for the identified vertex (act 906). For example, the path computation engine 108 uses the job profile 104 to iteratively identify parents of vertices from one parent to the next. While embodiments might typically identify parent relationships, it should be appreciated that in other embodiments, child relationships could be identified iteratively.

The method 900 further includes displaying a Gantt chart showing the identified path, wherein the Gantt chart shows timing relationships and execution progress information (act 908). For example, as illustrated in FIG. 4, a Gantt chart could be displayed to a user in a user interface showing parent-child relationships and timing of vertices identified in the path.

The method 900 may be practiced where identifying a vertex comprises identifying a last completed vertex and identify a single path parent-child sequence path for the identified vertex comprises identifying a critical path which includes the vertex.

The method 900 may further include receiving user input selecting one of the vertices, and as a result displaying statistics for the vertex. For example, as illustrated in FIG. 5, various statistics could be displayed for a selected vertex in a statistics window 406.

The method 900 may further include receiving user input selecting one of the vertices, and as a result displaying operations of the vertex. Thus, for example, as illustrated in FIG. 6, an illustration 414 of operations is shown.

The method 900 may further include receiving user input selecting one of the operations in the vertex, and as a result displaying code for the operation. Thus, as illustrated in FIG. 7, a user could select an operation 416 in the user interface. They system would then, as a result, display the code for the operation in the user interface as illustrated in FIG. 8.

The method 900 may be practiced where identifying vertices with a parent relationship to the identified vertex comprises streaming a file which includes a collection of timings and relationships for the vertices. For example, as described above, the job profile 104 could be streamed to identify timing and vertex relationships.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard. Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which conic within the meaning and range of equivalency of the claims are to be embraced within their scope.

1. A system comprising:
one or more processors; and
one or more computer-readable media having stored thereon executable instructions which, when executed by the one or more processors, cause the system to perform a computer-implemented method of improving performance of a distributed computational job by using dynamically collected timing and relationship information for vertices contained in various stages of the running job to identify a critical path for the running job, wherein the critical path is then used to resolve bottlenecks or other problems which improve the performance of the distributed computational job, and wherein the computer-implemented method comprises:
executing a distributed computational job comprised of a plurality of stages each comprising a set of computations applied to a given data element, wherein the stages are coupled to each other by various parent-child relationships and wherein each stage includes one or more vertices, each vertex comprising a set of related computations together with a particular instance of input data to be acted on;
as the computational job runs, dynamically collecting a job profile and storing the job profile in a database, where the job profile is a file that can be streamed and comprises timing information and relationship information for the vertices in the plurality of stages of the running computational job, and wherein the timing information comprises each vertex's creation time, queued time, executing time and completed time, each said time being stored when a particular vertex changes state, and wherein the relationship information comprises each vertex's parent vertex;
based on the job profile, identifying a critical path of the computational job, the critical path representing the longest running single path of any parent-child vertex sequence of the computational job, and wherein the critical path is identified by beginning at the last completed vertex, identifying a parent vertex of the last completed vertex, then identifying a parent vertex of the parent vertex of the last completed vertex, and so on, until a vertex at the start of the computational job is reached;
presenting the identified critical path in a timeline view showing all vertices along the critical path; and
selecting one or more of the vertices in the timeline view so as to cause a statistics window to appear presenting statistics for the one or more selected vertices on the critical path, and using the presented statistics to improve performance of the computational job by resolving bottlenecks or other problems for at least some of the vertices on the critical path.

2. The system of claim 1, wherein the method implemented by the one or more processors to dynamically collect timing and relationship information of each vertex contained the job profile comprises scheduling vertices based on compiled algebra, and wherein the compiled algebra is represented by a job graph displayed on an interface screen.

3. The system of claim 1 wherein presenting the identified critical path in a timeline view comprises displaying on an interface screen a first Gantt chart showing the identified critical path, including timing relationships of vertices in the critical path, and execution progress information for the vertices in the critical path, and wherein the computer-implemented method further comprises:
based on user input changing one of the vertices in the identified critical path causing the identified critical path to no longer be the critical path for the running computational job;
as a result, identify a new critical path; and
displaying a second Gantt chart showing the new identified critical path, wherein the new Gantt chart shows timing relationships and execution progress information for vertices in the new critical path.

4. The system of claim 3, wherein the computer-implemented method further comprises based on user input selecting one of the vertices in at least one of the first and second Gant charts, and as a result display statistics for the selected vertex.

5. The system of claim 3, wherein the computer-implemented method further comprises based on user input selecting one of the vertices in at least one of the first and second Gant charts, and as a result display operations of the selected vertex.

6. The system of claim 0, wherein the computer-implemented method further comprises based on user input selecting one of the operations in the selected vertex, and as a result displaying code for the selected operation.

7. The system of claim 1, wherein the method implemented by the one or more processors further comprise, when beginning at the last completed vertex identifying a parent vertex of the last completed vertex, then identifying a parent vertex of the parent vertex of the last completed vertex, and so on, until a vertex at the start of the computational job is reached, if a parent vertex is unable to be identified due to failure because of an error or due to the parent vertex running too long, starting another vertex with the same code as the failed parent vertex.

8. A computer-implemented method of improving performance of a distributed computational job by using dynamically collected timing and relationship information for vertices contained in various stages of the running job to identify a critical path for the running job, wherein the critical path is then used to resolve bottlenecks or other problems which improve the performance of the distributed computational job, and wherein the computer-implemented method comprises:
executing a distributed computational job comprised of a plurality of stages each comprising a set of computations applied to a given data element, wherein the stages are coupled to each other by various parent-child relationships and wherein each stage includes one or more vertices, each vertex comprising a set of related computations together with a particular instance of input data to be acted on;
as the computational job runs, dynamically collecting a job profile and storing the job profile in a database, where the job profile is a file that can be streamed and comprises timing information and relationship information for the vertices in the plurality of stages of the running computational job, and wherein the timing information comprises each vertex's creation time, queued time, executing time and completed time, each said time being stored when a particular vertex changes state, and wherein the relationship information comprises each vertex's parent vertex;
based on the job profile, identifying a critical path of the computational job, the critical path representing the longest running single path of any parent-child vertex sequence of the computational job, and wherein the critical path is identified by beginning at the last completed vertex, identifying a parent vertex of the last completed vertex, then identifying a parent vertex of the parent vertex of the last completed vertex, and so on, until a vertex at the start of the computational job is reached;
presenting the identified critical path in a timeline view showing all vertices along the critical path; and
selecting one or more of the vertices in the timeline view so as to cause a statistics window to appear presenting statistics for the one or more selected vertices on the critical path, and using the presented statistics to improve performance of the computational job by resolving bottlenecks or other problems for at least some of the vertices on the critical path.

9. The computer-implemented method of claim 0, wherein dynamically collecting timing and relationship information of each vertex contained the job profile comprises scheduling vertices based on compiled algebra, and wherein the compiled algebra is represented by a job graph displayed on an interface screen.

10. The computer-implemented method of claim 7, wherein presenting the identified critical path in a timeline view comprises displaying on an interface screen a first Gantt chart showing the identified critical path, including timing relationships of vertices in the critical path, and execution progress information for the vertices in the critical path, and wherein the computer-implemented method further comprises:
based on user input changing one of the vertices in the identified critical path causing the identified critical path to no longer be the critical path for the running computational job;
as a result, identify a new critical path; and
displaying a second Gantt chart showing the new identified critical path, wherein the new Gantt chart shows timing relationships and execution progress information for vertices in the new critical path.

11. The computer-implemented method of claim 10, further comprising based on user input selecting one of the vertices in at least one of the first and second Gant charts, and as a result display statistics for the selected vertex.

12. The computer-implemented method of claim 10, further comprising based on user input selecting one of the vertices in at least one of the first and second Gant charts, and as a result display one or more operations for the selected vertex.

13. The computer-implemented method of claim 8, further comprising based on user input selecting one or more operations for the one or more selected vertices, and as a result displaying code for the one or more selected operations.

14. The computer-implemented method of claim 0, wherein when beginning at the last completed vertex identifying a parent vertex of the last completed vertex, then identifying a parent vertex of the parent vertex of the last completed vertex, and so on, until a vertex at the start of the computational job is reached, if a parent vertex is unable to be identified due to failure because of an error or due to the parent vertex running too long, starting another vertex with the same code as the failed parent vertex.

15.-20. (canceled)

21. A computer-program product comprising one or more hardware storage devices having stored thereon executable instructions which, when executed by one or more processors, cause the system to perform a computer-implemented method of improving performance of a distributed computational job by using dynamically collected timing and relationship information for vertices contained in various stages of the running job to identify a critical path for the running job, wherein the critical path is then used to resolve bottlenecks or other problems which improve the performance of the distributed computational job, and wherein the computer-implemented method comprises:
executing a distributed computational job comprised of a plurality of stages each comprising a set of computations applied to a given data element, wherein the stages are coupled to each other by various parent-child relationships and wherein each stage includes one or more vertices, each vertex comprising a set of related computations together with a particular instance of input data to be acted on;
as the computational job runs, dynamically collecting a job profile and storing the job profile in a database, where the job profile is a file that can be streamed and comprises timing information and relationship information for the vertices in the plurality of stages of the running computational job, and wherein the timing information comprises each vertex's creation time, queued time, executing time and completed time, each said time being stored when a particular vertex changes state, and wherein the relationship information comprises each vertex's parent vertex;
based on the job profile, identifying a critical path of the computational job, the critical path representing the longest running single path of any parent-child vertex sequence of the computational job, and wherein the critical path is identified by beginning at the last completed vertex, identifying a parent vertex of the last completed vertex, then identifying a parent vertex of the parent vertex of the last completed vertex, and so on, until a vertex at the start of the computational job is reached;
presenting the identified critical path in a timeline view showing all vertices along the critical path; and
selecting one or more of the vertices in the timeline view so as to cause a statistics window to appear presenting statistics for the one or more selected vertices on the critical path, and using the presented statistics to improve performance of the computational job by resolving bottlenecks or other problems for at least some of the vertices on the critical path.

22. The computer program product of claim 21 wherein when beginning at the last completed vertex identifying a parent vertex of the last completed vertex, then identifying a parent vertex of the parent vertex of the last completed vertex, and so on, until a vertex at the start of the computational job is reached, if a parent vertex is unable to be identified due to failure because of an error or due to the parent vertex running too long, starting another vertex with the same code as the failed parent vertex.

23. The computer-program product of claim 21, wherein presenting the identified critical path in a timeline view comprises displaying on an interface screen a first Gantt chart showing the identified critical path, including timing relationships of vertices in the critical path, and execution progress information for the vertices in the critical path, and wherein the computer-implemented method further comprises:
based on user input changing one of the vertices in the identified critical path causing the identified critical path to no longer be the critical path for the running computational job;
as a result, identify a new critical path; and
displaying a second Gantt chart showing the new identified critical path, wherein the new Gantt chart shows timing relationships and execution progress information for vertices in the new critical path.

24. The computer-program product of claim 23, wherein the computer-implemented method further comprises based on user input selecting one of the vertices in at least one of the first and second Gant charts, and as a result displaying statistics for the selected vertex.

25. The computer-program product of claim 23, wherein the computer-implemented method further comprises based on user input selecting one of the vertices in at least one of the first and second Gant charts, and as a result displaying one or more operations for the selected vertex.

26. The computer-program product of claim 25, wherein the computer-implemented method further comprises based on user input selecting one of the operations in the selected vertex, and as a result displaying code for the selected operation.
